(19) United States
(12) Patent Application Publication
(10) Pub. No.: US 2007/0169143 A1
(43) Pub. Date: Jul. 19, 2007

(54) METHOD AND SYSTEM FOR INCREASING VIEWERSHIP AND VIEWER INTERACTION WITH PUBLIC EVENTS AND BROADCAST PRESENTATION

(76) Inventor: Kam W. Li, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/623,988

(22) Filed: Jan. 17, 2007

Related U.S. Application Data
(60) Provisional application No. 60/759,540, filed on Jan. 17, 2006.

(51) Int. Cl. H04N 7/173; H04N 7/16

(52) U.S. Cl. 725/23; 725/112; 725/113; 725/24

(57) ABSTRACT

A method and a communication network system for increased viewership of a public event or broadcast program which is affected by providing incentives to the viewers in the nature of a sweepstake program drawn from the viewers' responses to queries communicating to the viewers in connection with the event or broadcast presentation. Sweepstake rules are selectable to encourage viewer interaction and engagement with the presentation. Dynamic incentive drivers are applied in real time to further enhance viewer participation and excitement. Broadcast sponsor shares in the revenue generated by the service provider providing the communication services by which the viewers' responses are made in response to the queries.

### BACKGROUND

1. Field of the Invention

This invention relates to presentation of public events and broadcast of entertainment and media programs, and more particularly to a method and system for increasing audience and viewership of such events and programs.

2. Description of the Related Art

In presentation of public event, and entertainment and media broadcasting, audience and viewership is among the key business factors, which can determine the financial success of the endeavor. In particular, revenue in support of commercial broadcasting is usually derived from advertisements or commercials that accompany the presentation of the program. Manufacturers and service providers spend advertising dollars to attract demographically targeted viewers to promote their goods and services and they seek to maximize the viewership as much as possible. Within the targeted viewer population, a large audience for a broadcast program often carries increased pricing and higher rates that broadcast stations and program sponsors could charge for their advertising services. Consequently, increasing viewership is a prime business objective for commercial broadcast stations and program sponsors who depend on advertising revenues.

### SUMMARY OF THE INVENTION

The present invention provides a method and system for increasing the audience and viewership of a public event presentation or broadcast program. Viewers are invited to interact with the program presentation by answering to one or more queries associated with the program. The viewers' responses are communicated to the program sponsors via communication means such as telephones and by the Internet. The responses are collected and pooled by a central data receiving center, supported by a multi-media, multi-network server for qualification of one or more sweepstakes drawn based on predefined rules for the award of prizes to the participating viewers. Depending on the viewer participation level, increases in the sweepstake odds and/or the value of the prizes can be applied to affect viewer participation and interaction with the program presentation. Dynamic incentive drivers are applied in real time to further enhance viewer participation and excitement.

### BRIEF DESCRIPTION OF THE DRAWING(S)

FIG. 1 is a flow-chart showing the major steps involved in the present invention.

FIG. 2 is a high level network diagram showing the network communication system according to the present invention.

### DETAILED DESCRIPTIONS

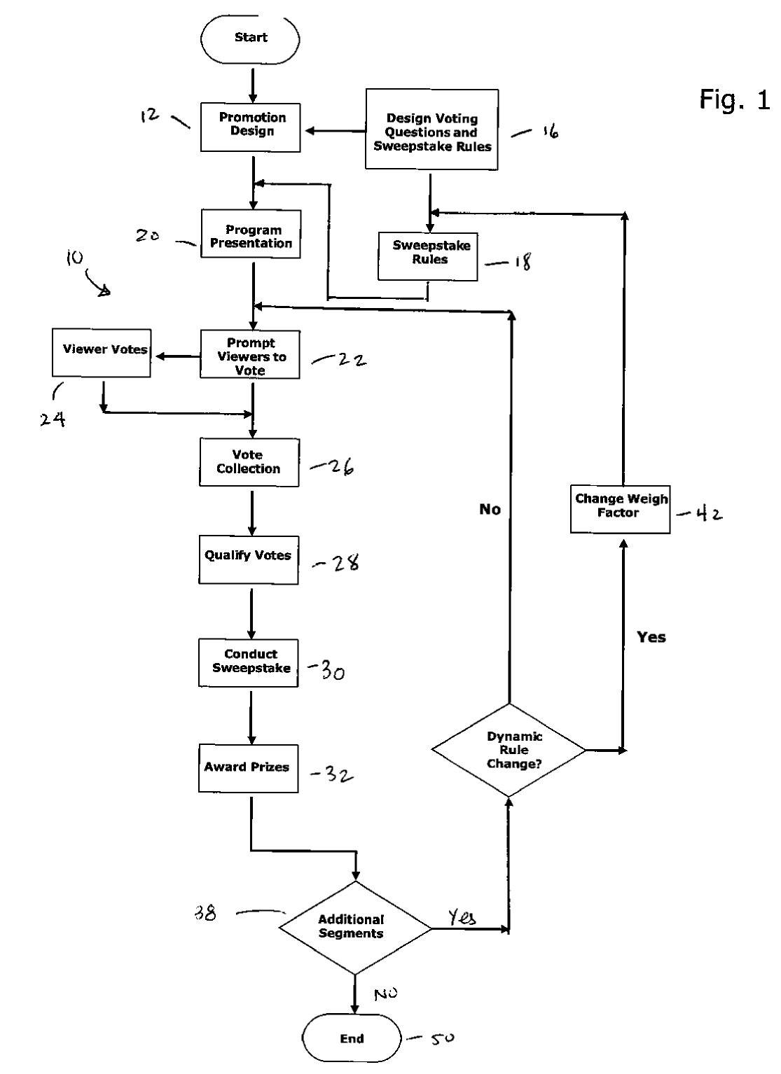

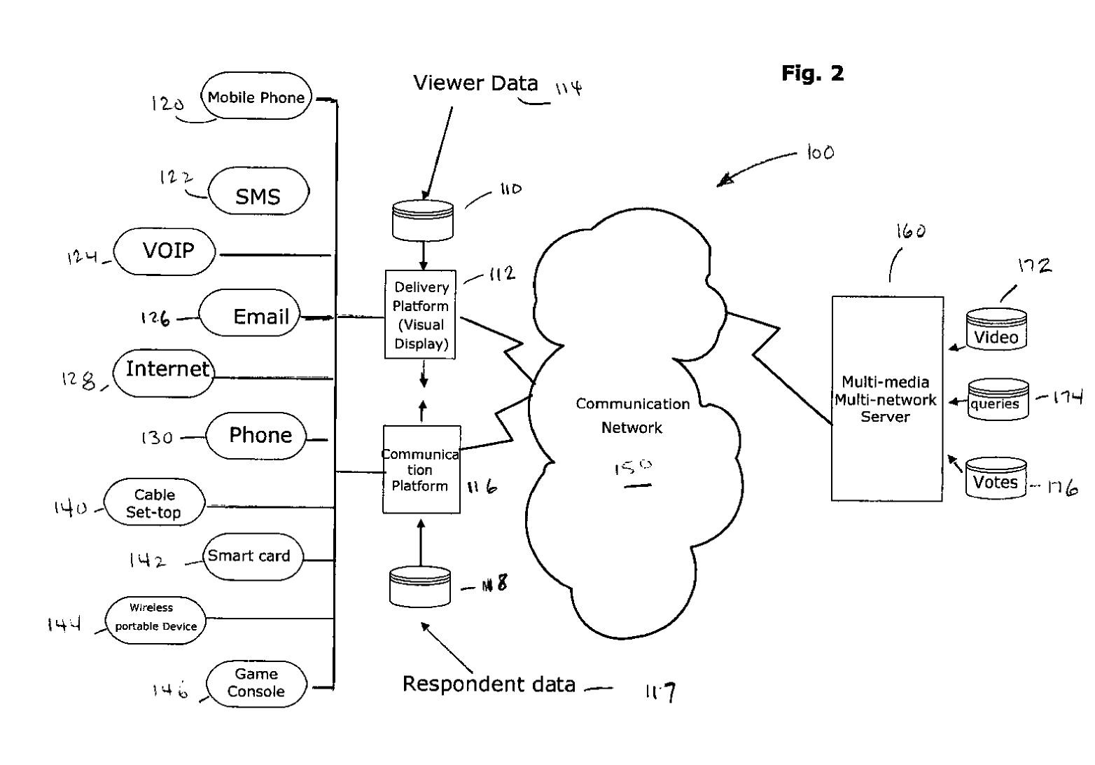

As shown in FIGS. 1 and 2, the present invention provides a method and system for conducting a sweepstake for increasing audience and viewership of a public event presentation or broadcast program. The invention incorporates the steps of inviting viewers to view the presentation, which may be presented live, by means of a television broadcast system, or various other audio and video means. The viewers are then Prompted to respond to one or more queries, which are contextually related to the presentation and to submit their responses by communication means. The viewers responses are then qualified according sweepstake rules on which prizes are awarded.

The present invention is applicable to various settings where public events and programs are presented. These events and programs could be a sports competition, talent shows, beauty contest, or the like, which preferably has at least one program segment, an episode or series of segments or episodes. An example of a broadcast event is a boxing match, which includes a number of boxing rounds (program segments).

The public event and broadcast programs can be presented at various venues, through media and entertainment channels, or by any of combinations thereof. For easy of discussion herein, reference is made of a broadcast program, which is presented to the public for viewing via common communication means such as television systems (over-the-air and cable television), multi-media enabled mobile telephones, online computer systems, electronic billboards, portable devices such as personal desk assistants (PDA's), game consoles or the like.

FIG. 2 shows a high level network diagram, which illustrates an exemplary multi-network communication system 100, which is adaptable for the present invention for a multimedia program presentation 20. Presentation of the broadcast program is administered by a multimedia communication server 160, which processes information from the server 160 and delivers it to the viewers on delivery platforms 112. Examples of delivery platforms 112 are television sets, video monitors, video mobile phones, and wireless PDA's, the communication means with which the broadcast program is presented.

As shown in FIG. 2, the multi-network server 160 is connected to an access platform 112 and a delivery platform 116. The server 160, which is part of a call-in center (not shown), is configured with one or more data storage facilities holding audio and video files 172, queries 174, responses/or votes 176, and other databases and appropriate computer software in support of the administrative and operational functions of the viewership promotion program.

The inventive method 10 of the present invention is deployable in connection with the broadcast presentation. As shown in FIG. 1, directed to the presentation 20, the audience or the viewing public is invited to respond to one or more queries, 22, on which the viewers will be entitled to a sweepstake draw, 30 and rewards, 32.

To cultivate viewer engagement with the program presentation, the queries are preferably contextualized. They are formulated to relate to the content, and/or themes of the presentation as part of the promotion design, 12. The contextualization causes the viewers to create a mental and emotional association with the presentation on which they are challenged to respond.

Thus for the example of a boxing match presentation, a query can be asked as to the possible winner of the boxing contest. To answer the query, the viewers would wish to watch and judge the performance of the contestants during the various rounds of the boxing match. This creates a sense of personal attachment to the outcome of the boxing contest and the viewers are attracted to the presentation. The dynamics of a boxing contest having different possible outcomes of a winner and a loser further add excitement to the viewer participation.

The queries are expressed as objective question types, which may include true/false, multiple choice, multiple-response and matching questions, on which viewers are invite to provide a simple, non-narrative manner response. Examples of such answers/choices are “yes” and “no,” “‘1,’ ‘2,’ ‘3,’ . . . ” and “‘a,’ ‘b,’ ‘c.’ . . . . ” Thus for the exemplary boxing match presentation, to answer the question “Who is your choice of the winner of the fight?” the viewers choices are limited to “Boxer A” and “Boxer B.” Invitation to the viewers to participate in the response in step 22, can be prompted during the program broadcast, or closely in time, prior to or after the presentation 20, so correlation can may be established between the broadcast of the program and viewer participation.

The viewers axe prompted to cast their responses by the communication platform or means 116, as shown in FIG. 2. Example of such communication means include a mobile telephone 120 and a land-based telephone 130, which is adaptable to enable the identification of the individual respondents. The responses may be by dialing in on the mobile telephone 120 or the land-based telephone 130 on a pre-assigned telephone number, which corresponds to the viewer's choice of the response. In the case of the two boxing contestant, there can be a plurality of pairs of pre-assigned telephone numbers each of which represents a boxing contestant.

As shown in FIG. 2, in the Internet online environment, the viewer respondent may communicate their responses with a pre-assigned web-site from their online computer terminals 128. Where the program presentation is broadcast in a cable television system adapted with viewer-interactive set-top boxes controllable by a remote control, a viewer's response may be submitted by the remote control to cable system operator by way of the set-top box 140. Additionally, the viewer responses can be collected in a smart card system (such as those which are being used in a number of modern mass transit system) where the viewer respondents can cast and register their responses by placing their smart-cards 142 in direct physical contact or remotely via a contactless electromagnetic interface with the card readers. While the above illustrates the communication platforms or means in which viewer responses can be submitted, they are not exclusive of other means with which the responses can be cast and received. As shown in FIG. 2, viewers' responses 24 are sent over the communication network 150 via the access platform 118 to the multi-network communication server 160

The viewers' responses are each individually identifiable to the particular viewer-respondent as respondent data 117. This can be accomplished by various approaches. In one embodiment of the present invention, the viewers are prompted to cast their responses by way of telephone sets each of which is individually identifiable by the telephone services provider when the call is made. In another embodiment of the inventions the viewers are requested to submit their responses online from their computer terminals on a website hosted at a remote server where identifiable user information is collected. Where computer terminals are identifiable also by their Internet Protocol (IP) addresses, they can be linked to the viewer respondents.

In the example as described above, the program presentation and communication viewer responses are handled by different equipment, that is, television system and telephone services or online computer terminal. Alternatively, the broadcast presentation and viewer responses can be processed on a single equipment platform. In one embodiment of the present invention, the program presentation is carried on mobile phone systems, which offer multimedia and internet access with the ability to Viewers' responses 24 are sent over the communication network 150 via the access platform 118 to the multi-network communication server 160 enable video display, as well as and/or text messaging services. While watching the program presentation, the mobile phone user is prompted to dial in the response to the query with keypad selection and/or text messaging electing the response. A similar application can be made of a computer terminal having broadband Internet access adapted for interaction with the broadcast. The broadcast program can be displayed on the terminal via video streaming while the viewer may communicate his or her response online or by email. In each of these embodiments, the equipment used is enabled to render each response to be identifiably associated the equipment or with the particular respondent so a winning sweepstake draw can be readily associated with the associated viewer-participant. As shown in FIG. 2, a communication network 150 connects the 160 to the access platform 112 and delivery platform 116.

As referenced above, because viewer participation is prompted closely in time to the program presentation, a correlating measure between the broadcast of the program and viewer participation can be established. Further, because the responses are each individually identifiable to associate with a unique viewer, the number of the responses can meaningfully represent the level of viewership on a real time basis.

The present invention provides that at least one sweepstake be drawn on the viewer responses, with prize awarded to those who participate, which provides an incentive to increase viewership and sustained viewer engagement. As shown in FIGS. 1 and 2, the viewer responses are cast and collected, as in step 26, at a call-in center (not shown) which is supported by a multimedia/multi-network server 160. The server 160 includes but is not limited to computer and storage means and supporting software. There the viewers' responses are analyzed to ensure that they are qualified under the rules of the sweepstakes step 28. Following rule qualification, the responses are pooled, on which the sweepstake is drawn, step 30.

The sweepstake rules can be based on a number of criteria, which are to facilitate the administration of the viewership enhancement program and regulation of the sweepstakes. By way of examples, the rules may include a requirement that the responses be received by the call-in center and registered by the server 160 within certain predefined period(s) of time. The rules may also specifically require the permissible communication means, selected from any one of mobile phone 120, short message service 122, voice-over IP 124, email service 126, the Internet 128, land based telephone 130, cable set-top 140, smart-card 142, wireless portable device 144, or Game console 146, or any combination thereof, by which the responses are to be transmitted. Further the rules may limit the maximum number of responses that any individual viewer may submit. Preferably, the sweepstake rules are communicated to the viewers in advance of the presentation 20 so they would become familiar with the sweepstake and participate with confidence as expected on the part of informed participants.

The sweepstake rules may also be designed based on the nature of the program presentation so as to maximize viewer interactivity. To achieve such objective, various criteria with which the viewers may participate can be considered.

In the above-referenced example of a boxing match where two contestants will engage in a match for a predetermined number of boxing rounds, each round is considered a segment of the broadcast program. To encourage viewership and viewer interaction with the boxing event, the viewers are invited to vote for their choice of the winner contestant by calling pre-assigned telephone numbers, which correspond to the boxing contestants. Prior to the start of a boxing round, the viewers are prompted to vote for their favored boxing contestant as the possible winner, which votes must have been submitted and registered with the central telephone call-in center prior to the start of the boxing round. Provided the votes are cast accordingly, they are eligible for the sweepstake draw on which prizes.

In one embodiment of the present invention, the sweepstake is drawn on all the qualified responses submitted. That is, provided the viewers' votes 24 have been registered at the server 160 as pursuant to the instruction of the prompt, they will be pooled for the sweepstake without regard to whether the participants might have correctly identified the winner boxer in their votes. Upon the draw of the sweepstake, the winners will be declared and contacted for the award of the prizes, step 32.

If at the end of the round no winner is declared, the viewers are prompted to cast their votes for their choice of the winner for the subsequent round(s) before the fight would begin. The invitation to participate will be continued until a winner is declared or until all the rounds is complete. On such occasion, the sweepstake rules provide that all votes cast in previous rounds would be cumulatively pooled for the sweepstake. Such an arrangement increases the sweepstake odds for those viewers participating early and continuously throughout the various rounds (segments) of the boxing contest, thus increasing viewer interaction with the program presentation.

In this embodiment, the sweepstake rules may optionally provide that each viewer may only cast one vote for each round though there is no restriction on the number of rounds that the same viewer may cast a vote.

As referenced above, the viewers are prompted to cast their votes for registration with the telephone call-in center prior to the start of the boxing round. This limitation is to discourage last minute vote casting, which could provide an unfair advantage to those who elect to delay casting their votes until the appearance of a winner is about to emerge.

In another embodiment of the present invention, this limitation is modified to provide more time for the viewers to participate in the voting. In this alternative embodiment, the viewer participants are allowed to submit their votes any time before and during the start of the boxing round. Thus as long as their votes are registered for the round in interest they will be pooled for the sweepstake draw provided that no winner is declared in the round.

To avoid the unfair advantage of the late viewer participant, the sweepstake rules may provide that the sweepstake be drawn from those votes cast no later than a certain time, for example, 10 seconds prior to the referees' declaration or a knock-out, which ever is earlier. In addition to providing more time for the viewers to submit their votes, this approach is deemed to create a sense of unpredictability and excitement to the viewer participants. As a further variation in the embodiments of the present invention, all qualified votes cast prior to the round where the boxing winner is declared, either with or without regard to the correct winning votes cast, could be pooled together with the correct votes in a decision round for the sweepstake. Additionally, to increase the viewers' attachment to the program, weigh-factors can be added to increase the odds of the winning votes in the sweepstake draws.

Selectively, the present invention can include a provision for the dynamic change of the sweepstake odds, step 40 which is based on the level of viewer participation to add further excitement, as well as incentive to the viewers' participation. As an example, where viewer participation is outside a certain predetermined level in any program segment, where weigh-factors are assigned to the votes cast for one or more subsequent program segments to encourage viewer participation. Further, the weigh factors can be optionally randomly drawn from a predefined range of values or multiples to give weigh advantage to those who participate to create their odd in winning the sweepstake, step 42. In addition to having increased odds for participation, the viewing public is also intrigued by the randomness with which the weigh factor is selected, thus adding excitement to the viewers. Thus the present invention provides for an incentive driver, which is dynamically deployable at real time to affect viewership.

The sweepstake is randomly drawn from the pool of the qualified votes by using any one of the commonly used methods. The value of the sweepstake prizes can be based a number of financial and economic factors, which can be related to the revenue generated from various sources associated with the event or broadcast presentation. These revenue sources may include viewers subscription charges, pay-per-view subscriptions, and advertising fees from products and services providers (on television broadcast or web based advertising). In addition, at least a portion of the charges for dedicated telephone services, as well as for mobile phone usage from viewers' participation can also be collected as another revenue source on which the values of the sweepstake prizes can be calculated. Following the sweepstake draws, the winners can be announced and notified in a customary manner, which is not discussed in detail here.

As described above, the sweepstake rules are adoptable for attraction of viewership and sustained viewer engagement with a public event or a broadcast program. Depending on the nature and context of the presentation, the sweepstake rules can be changed for defining the odds of the sweepstake and the potential rewards. Various factors may be incorporated into the sweepstake rules, which provide the incentives and rewards to the participants. These factors include the contextual nature of the content of the presentation, the number of responses solicited based on the content of the presentation, the number of presentation segments, the choices of outcome that can be made, the number of responses a participant may submit, the time period for submitting the response, the weighs assigned to the responses, and the value of the sweepstake prizes.

In the above description, the inventive method has been described with reference to a boxing match that is presented in a public forum or by way of a video and audio (e.g., television) broadcast However, the present invention can also be applied to other public event and broadcast presentation. For example, instead of the boxing match as described, the televised program can be a beauty contest or a talent show wherein the contestants seek to compete for the top ranks and the viewer participants are prompted to vote for their favorite winners at the several rounds during the course of the presentation. A similar example is referenced of a televised reality shows featuring “ordinary” people engaged in unscripted contests.

In addition to presentations featuring live persons engaged in competitions, the present invention can be used to other subject matters for which information about the viewers' preferences and choices are desired. As an example, the present invention is adaptable to the presentation of a number of new songs which are yet to be introduced to the general public. In connection with the broadcasting of these new songs, audience and viewers can be prompted to vote for their favorite songs on which a statistical database can be developed for the determination of the song ranking.

The foregoing description shows the versatility of the system and methodology of the invention for allowing viewers of a public event or broadcast program to participate in a game, or other form of show, contest, game of chance, making predictions of the outcomes of unknown or future events, whether the presentation is live, prerecorded, or partially prerecorded and partially live.

It is to be understood that the above described embodiments of the invention are illustrative only, and that modifications thereof may occur to those skilled in the art. Accordingly, this invention is not to be regarded as limited to the embodiments.

What is claimed is:

1. A method for conducting a sweepstake for increasing audience and viewership of a presentation of a public event or broadcast program comprising the steps of:
(i) inviting viewers to view the presentation selectively by public viewing or via audio and video means, the presentation having at least one program segment;
(ii) prompting the viewers to respond to one or more queries contextually related to each program segment according to predetermined criteria, each query being answerable by a non-narrative response via predefined communication means for registration of the viewer's responses, wherein the responses are each identifiable in association with the viewers registering the responses;
(iii) qualifying the responses according predefined sweepstake rules for a sweepstake drawing;
(vi) conducting a sweepstake from the responses; and
(v) awarding a prize to the sweepstake winner among the viewers.

2. The method of claim 1 wherein and the video and audio means comprises one of wireless television, cable television, online computer display terminal, electronics billboards, personal desk assistant (PDA), mobile telephone with a display screen, and screen telephone.

3. The method of claim 1, wherein the broadcast event consists of one of a sport competition, beauty contest, talent show, and reality show.

4. The method of claim 1, wherein at least one of the queries substantially comprises an objective question contextually related to the broadcast event for which a non-narrative response yes or no response is solicited of the viewers.

5. The method of claim 1, wherein the communication means for the viewers' response is consisted of at least one of land-based telephone, mobile telephone, smart card system, and online computer system.

6. The method of claim 1, wherein the broadcast event is a sport competition event comprising either a boxing match or a wrestling match and the program segment is correspondingly a boxing or wrestling round.

7. The method of claim 6, wherein the communication means comprises at least two telephone lines each identifying the unique boxing or wrestling contestants in the boxing or wrestling match.

8. The method of claim 6, wherein the communication means comprises at least one telephone line in connection with the telephone system adapted to engage the viewers to register the responses following connection between the viewer and the telephone system.

9. The method of claim 7, which further comprises requesting each viewer to dial in the telephone line corresponding to the viewer's choice of a winner of the sport competition event

10. The method of claim 1, wherein the viewer is identifiable by the communication means by which the viewer's response is communicated for registration for the sweepstake.

11. The method of claim 10, wherein the communication means is selected from one of a telephone and an online computer system for which unique identifiers to the subscribers are associated.

12. The method of claim 10, wherein the communication means comprises a telephone and an online computer system selectable by a viewer for communication of the responses for the sweepstake.

13. The method of claim 1, wherein the televised program is consisted of one of a beauty contest or a talent show wherein the contestants seek to compete for the top ranks and the viewer participants are prompted to vote for their favorite winners at the several rounds during the course of the presentation.

14. The method of claim 1, wherein the broadcast presentation is a televised reality shows featuring “ordinary” people engaged in unscripted contests.

15. The method of claim 1 wherein the values of the sweepstake awards are at least partially based on the amount of the charges collectible from the communication services with which the viewers communicate their responses.

16. The method of claim 1, which further comprises the step of collecting a fee based on the charges collectible from the communication services with which the viewers communicate their responses.

17. The method of claim 1 wherein the broadcast event is the presentation of a plurality of songs for which the viewers are prompted to vote for their favorite songs

18. The method of claim 14, which further comprises the step of developing a statistical database for the determination of the song ranking.

19. The method of claim 15 which further comprises the step of applying a weighing factor to a viewer's qualified registered vote to increase the chances of the viewer being awarded a prize in the sweepstake.

20. The method of claim 19 wherein the weighing factors are randomly drawn from a range of predefined values.

21. The method of claim 20, wherein the step of awarding the weighing factor is applied based on predetermined viewer participation level.

22. The method of claim 21, wherein application of the weighing factor is made to each of the segments of the broadcast event.

23. The method of claim 1 wherein viewer participation in registering the responses is limited to a predefined time period.

24. A process for conducting a sweepstake for increasing viewer engagement of a presentation of a public event or a broadcast program comprising the steps of:
(i) inviting audience to view the presentation presented live or via audio and video means, the presentation having at last one program segment (episode or series of segments or episodes);
(ii) communicating to the viewers one or more contextualized queries for each program segment according to predetermined criteria, each query being answerable by a non-narrative response and adaptable to form a database illustrative of the viewers' individual preferences;
(iii) inviting the viewers to cast a response to at least one of the plurality of queries associated with at least one of the segment via communication means for registration of the viewers responses for each segment, each response being identifiable in association with each of the viewers;
(iv) qualifying the responses according predefined sweepstake rules for a sweepstake drawing;
(v) conducting a sweepstake from the responses; and
(vi) awarding a prize to the sweepstake winner among the participating viewers;

25. The method according to claim 24, which Her comprises the step of collecting at least a portion of the fee based on the charges collectible from the communication services with which the viewers communicate their responses.
